(19) United States
(12) Patent Application Publication
(10) Pub. No.: US 2013/0021989 A1
(43) Pub. Date: Jan. 24, 2013

(54) Methods, Apparatuses and Related Computer Program Product for Control Information Signaling

(71) Applicants: Esa Tapani Tiirola, Kempele (FI); Timo Erkki Lunttila, Espoo (FI); Kari Pekka Pajukoski, Oulu (FI); Kari Juhani Hooli, Oulu (FI); Peng Chen, Beijing (CN); Tommi Tapani Koivisto, Espoo (FI)

(72) Inventors: Esa Tapani Tiirola, Kempele (FI); Timo Erkki Lunttila, Espoo (FI); Kari Pekka Pajukoski, Oulu (FI); Kari Juhani Hooli, Oulu (FI); Peng Chen, Beijing (CN); Tommi Tapani Koivisto, Espoo (FI)

(73) Assignee: NOKIA CORPORATION, Espoo (FI)

(21) Appl. No.: 13/520,772

(22) PCT Filed: Jan. 7, 2010
(86) PCT No.: PCT/EP10/50097

§ 371 Date: Sep. 5, 2012

(51) Int. Cl. H04W 72/04

(52) U.S. Cl. 370/329

(57) ABSTRACT

Methods, apparatuses and related computer program product for control information signaling. It is disclosed a method/apparatus comprising predetermining, specifically for each of a plurality of terminals, a transmission mode in correspondence with a predetermined second control information format, transmitting, in a first predetermined portion of a set of control channel candidates, a first control information format of a first size, defining, based on the second control information format, a scheduling grant format of a second size different from the first size to be applied on a second predetermined portion of the set of control channel candidates, equating the first size so as to match with the second size, and transmitting, in the second predetermined portion, the equated first control information; and a method/apparatus comprising monitoring, in the first and second predetermined portions, reception of the first control information format, upon reception of a configuration message relating to the transmission mode, continuing the monitoring and monitoring reception of the scheduling grant format.

### FIELD OF THE INVENTION

An example of the present invention relates to control information signaling. More specifically, the example of the present invention relates to methods, apparatuses and a related computer program product for control information signaling. The example of the present invention may be applicable e.g. to a long term evolution (LTE)-Advanced system, which may be part of 3^{rd} generation partnership (3GPP) LTE release 10 (Rel-10) (and beyond). More specifically, the example of the present invention may relate to downlink control information (DCI) transmission e.g. on the physical downlink control channel (PDCCH) and may be applied in the context of LTE-Advanced uplink features such as single-user multiple-input multiple-output (SU-MIMO), clustered resource allocation within the UL component carrier (CC) as well as cross-CC scheduling.

### BACKGROUND

The PDCCH may carry DCI, which may in turn include resource assignment (RA) and other control information for a user equipment (UE) or group of UEs. Each PDCCH may be transmitted using e.g. one or more control channel elements (CCEs). Different PDCCH sizes with different CCE aggregation levels (comprising 1, 2, 4 or 8 CCEs) are supported e.g. in LTE Rel-8.

The UE may need to decode all possible PDCCH sizes and locations in order to process messages with a correct cyclic redundancy code (CRC) scrambled with a UE identity. Carrying out such blind decoding of all possible combinations (of PDCCH sizes and locations) in every sub-frame may lead to excessive power consumption and processing time requirements at the UE side as well as increased probability of false uplink/downlink (UL/DL) grant detection.

FIG. 1 shows an exemplary structure for control information signaling. In order to limit the number of blind decoding attempts, only a limited set of CCE locations may be used, in which set it is set where a PDCCH may be placed for each UE. The limited CCE set may be considered as a PDCCH search space, which may be divided into common part with 6 PDCCH candidates and dedicated part with 16 candidates, respectively. These candidates may need to be decoded twice as there are two size options defined for the PDCCH both in common and in dedicated search space. This gives the maximum number of PDCCH blind decoding attempts (=44, i.e. 2*(6+16)), which may be required to be carried out in any sub-frame.

LTE-Advanced uplink features such as SU-MIMO, clustered resource block mapping and cross-CC scheduling may require support e.g. on the DL resource assignment signaling side. The common nominator of these features resides in that they may require e.g. a larger DCI payload size compared to a physical uplink shared channel (PUSCH) grant (e.g. DCI Format 0):

SU-MIMO with 2-Tx antennas may require DCI of additional 5 bits or more;

SU-MIMO with 4-Tx antennas may require DCI of additional 8 bits or more;

Clustered RB mapping may require additional N bits, since a subject of further study may be how many additional DCI bits are required by clustered allocation. This number depends mainly on how many clusters are supported (e.g. 2 . . . unlimited). Another issue resides in the question of what degree of freedom is allowed for clustered resource allocation with respect to cluster size and cluster placement;

cross-CC scheduling may require 3 additional DCI bits (e.g. carrier indicator field (CIF)).

It is also to be noted that SU-MIMO, clustered RB mapping and cross-CC scheduling may be supported at the same time, which in turn may mean additional size options for UL resource allocation grant. Furthermore, it is possible to configure a multi-antenna UE to appear as a legacy UE, i.e. to have a fallback to single antenna transmission.

There have been approaches dedicated to solve the above issues.

As shown in FIG. 1, additional DCI size options may, by default, increase the number of blind decoding and also the probability of false positive decoding. This is shown in FIG. 1, where the column “Size 3” may correspond to an UL grant (DCI Format 0′) e.g. for an additional UL feature (e.g. SU-MIMO). However, the PDCCH blind decoding burden is increased by 50% compared to that of a legacy system (e.g. Rel-8).

Another approach has been proposed. As shown in FIGS. 2A and 2B, it has been considered how to design the UL RA jointly for multi-cluster and SU-MIMO operation without increasing the number of PDCCH blind decodes and maintaining the capability to assign UL resources to LTE-Advanced UEs using e.g. the Rel-8 approach (fallback). Two alternative designs may be provided e.g. for UL resource allocation according to these criteria:

FIG. 2A: DCI formats used for clustered resource allocation (denoted as “0”) and SU-MIMO (denoted as “2A′, 2′”) may be based e.g. on a UL grant (0) and downlink open-loop/closed-loop MIMO grants (2, 2A);

FIG. 2B: DCI format 0/1A is left unchanged, while additional uplink DCI formats (denoted by “1′, 2A′, 2′, 1D′, 1B′”) are made DL transmission mode dependent.

In consideration of the above, according to the example of the present invention, methods, apparatuses and a related computer program product for control information signaling are provided.

In this connection, the examples of the present invention enable one or more of the following:

Maintaining PDCCH scheduling flexibility, e.g. with respect to introducing support for e.g. cross-CC scheduling or some other optimized UL formats;

Enabling legacy (e.g. Rel-8) fallback dynamically available all the time e.g. via DCI format 0 for e.g. retransmissions;

Avoiding any coupling between UL mode and DL mode, thus enabling an evolved nodeB (eNB) to configure the UL SU-MIMO based on the UL's needs only. In other words, no connection is made between UL Tx mode and DL Tx mode, i.e. there is complete freedom to choose the UL and DL Tx modes independently. The same may apply to clustered allocation;

Avoiding preclusion of the use of e.g. UL MIMO with time division duplex (TDD) beamforming;

Avoiding a large size of the formats (1′, 2A′, 2′, 1D′ 1B′);

Enabling a cost-efficient dynamic fallback to legacy (e.g. multi-antenna→single antenna port mode);

Keeping the PDCCH blind decoding burden at a predetermined (e.g. Rel-8) level;

Enabling a flexible design: size of UL grant can be optimized separately for different use cases (e.g., SU-MIMO with 2-Tx, SU-MIMO with 4-Tx with or without clustered transmission), thus minimizing UL grant overhead.

### BRIEF DESCRIPTION OF THE DRAWINGS

The example of the present invention is described herein below with reference to the accompanying drawings, in which:

FIG. 1 shows an exemplary structure for control information signaling;

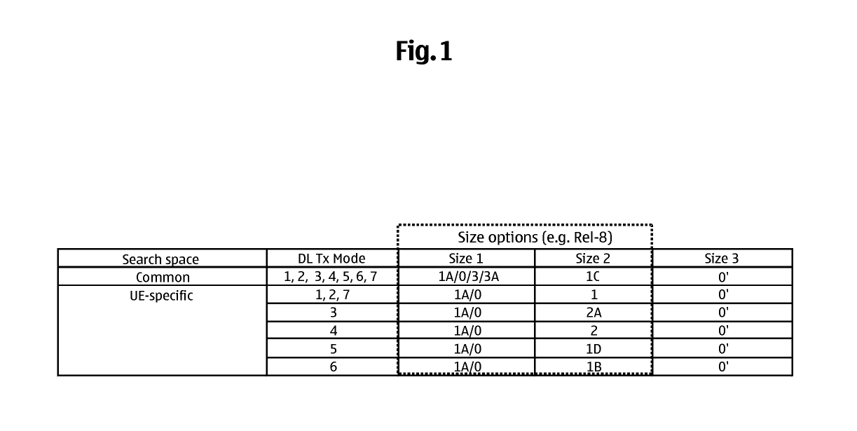

FIG. 2 shows an example of resource allocation;

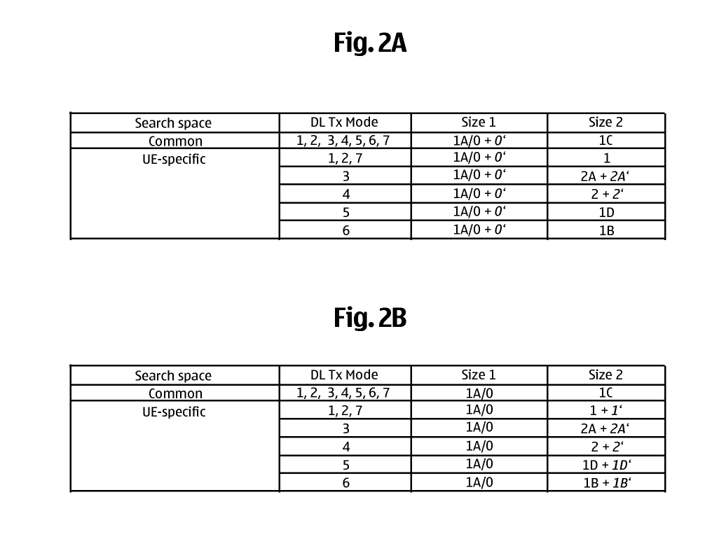

FIG. 3 shows the principle underlying the example of the present invention;

FIG. 4 shows methods for control information signaling according to the example of the present invention;

FIG. 5 shows apparatuses for control information signaling according to the example of the present invention; and

FIG. 6 shows a development of the example of the present invention.

### DETAILED DESCRIPTION OF THE EXAMPLE OF THE PRESENT INVENTION

The example of the present invention is described herein below by way of example with reference to the accompanying drawings.

It is to be noted that for this description, the terms “uplink transmission mode; downlink control information format being related to at least one of single-user multiple input multiple output, clustered resource block mapping and cross component carrier scheduling; set of control channel elements for the physical downlink control channel; and downlink control information format 0 or downlink control information format 1A” are examples for “at least one transmission mode; second control information format; set of control channel candidates; and first control information format”, respectively, without restricting the latter-named terms to the special technical or implementation details imposed to the first-named terms. Further, it is to be noted that the term “transmitting” (both in method and apparatus terms) is meant to relate to providing a transmission opportunity and/or to transmitting as a separate function (e.g. in case the eNB decides to schedule a control channel (e.g. PDCCH) for the UE with the (e.g. special mode).

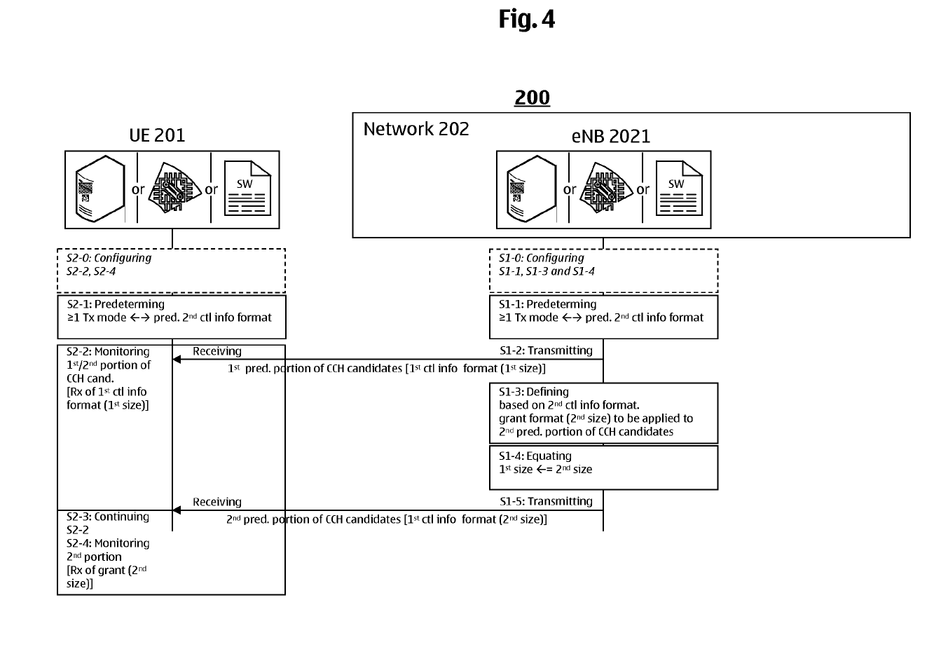

FIG. 4 shows the methods for control information signaling according to the example of the present invention. Signaling between elements may be indicated in horizontal direction, while time aspects between signaling may be reflected in the vertical arrangement of the signaling sequence as well as in the sequence numbers. It is to be noted that the time aspects indicated in FIG. 4 do not necessarily restrict any one of the method steps shown to the step sequence outlined. This applies in particular to method steps that are functionally disjunctive with each other. Within FIG. 4, for ease of description, means or portions which may provide main functionalities are depicted with solid functional blocks or arrows and/or a normal font, while means or portions which may provide optional functions are depicted with dashed functional blocks or arrows and/or an italic font.

As shown in FIG. 4, a communication system 200 may comprise a UE 201 and a network 202. In turn, the network 202 may further comprise an evolved nodeB (eNB) 2021.

As an optional preparatory measure, in step S1-0, e.g. the eNB 2021 may perform configuring predetermining (see step S1-1 herein below), defining (see step S1-3 herein below) and equating (see step S1-4 herein below) based on higher layer signaling. As an optional preparatory measure, in step S2-0, e.g. the UE 201 may perform configuring monitoring (see steps S2-2 and S2-4 herein below) based on higher layer signaling. In these cases, the higher layer signaling may be constituted by dedicated radio resource control signaling. Alternatively, the higher layer signaling may be constituted by a preset hardware specification.

In steps S1-1 and/or S2-1, e.g. the eNB 2021 and/or the UE 201 may perform predetermining, specifically for each of a plurality of terminals, at least one transmission mode (e.g. an UL transmission mode) in correspondence with a predetermined second control information format (e.g. DCI format 0′, 0″, 0′″ etc.).

Then, in step S1-2, e.g. the eNB 2021 may perform transmitting, in a first predetermined portion of a set of control channel candidates (e.g. control channel elements (CCEs) for PDCCH), a first control information format (e.g. DCI format 0/1A) of a first size (e.g. size of DCI format 1A).

In step S2-2, e.g. the UE 201 may perform monitoring, in the first and second predetermined portions of the set of control channel candidates, reception of the first control information format of the first size.

In step S1-3, e.g. the eNB 2021 may perform defining, based on the second control information format, a scheduling grant format (e.g. UL grant format) of a second size different from the first size to be applied on a second predetermined portion of the set of control channel candidates.

Further, in step S1-4, e.g. the eNB 2021 may perform equating the first size so as to match with the second size.

Finally, in step S1-5, e.g. the eNB 2021 may perform transmitting, in the second predetermined portion, the equated first control information (e.g. DCI format 0′ or 1A′).

In step S2-3, e.g. the UE 201 may perform continuing, upon reception of a configuration message relating to the at least one transmission mode, the monitoring.

In step S2-4, e.g. the UE 201 may perform monitoring, upon reception of the configuration message relating to the at least one transmission mode, reception of the scheduling grant format of the second size, the scheduling grant comprising the second control information format (e.g. DCI format 0′/1A′) in the second predetermined portion. In this case, the monitoring may comprise an operation in a single-antenna-port mode.

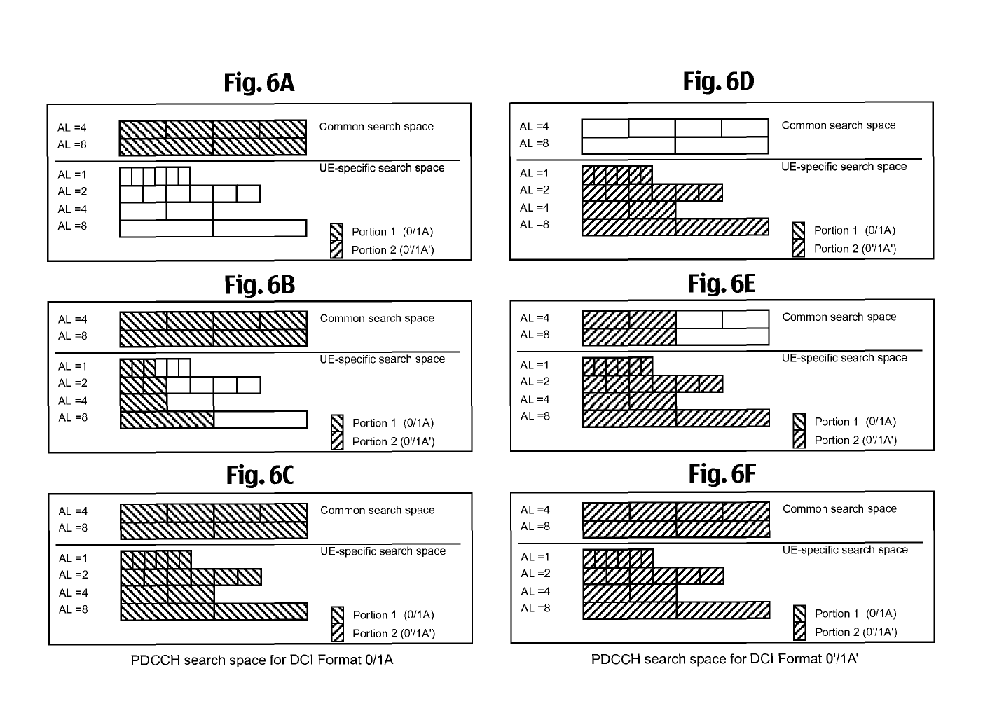

FIG. 6 shows a development of the example of the present invention. Each one of FIGS. 6A to 6F shows search spaces for the control channel (e.g. PDCCH), i.e. FIGS. 6A to 6C show the search spaces for the first control information (e.g. DCI format 0 or 1A), while FIGS. 6D to 6F show the search spaces for the second control information (e.g. DCI format 0′ or 1A′). Further, in each one of FIGS. 6A to 6F, the one third on the top indicates the so-called common search space and the two thirds on the bottom indicate the so-called UE-specific search space. In addition, the term “aggregation level” (abbreviated as “AL” in FIGS. 6A to 6F) relates to the number of resource elements (e.g. CCEs) usable for the respective control channel candidate; that is, the common search space can comprise up to 6 control channels (up to 4 channels each having 4 resource elements and up to 2 channels each having 8 resource elements), and the UE-specific search space can comprise up to 16 control channels (up to 6 channels each having 1 resource element, up to 6 channels each having 2 resource elements, up to 2 channels each having 4 resource elements and up to 2 channels each having 8 resource elements). It is to be noted that the configuration of UE-specific and common search spaces is not limited to the example shown in FIG. 6.

As shown in FIG. 6, as for those developments pertaining to the eNB 2021 and the UE 201, the first predetermined portion may be constituted by the common search space of the physical downlink control channel (see FIG. 6A). Further, the second predetermined portion may be constituted by the user equipment-specific search space of the physical downlink control channel (see FIG. 6D). Still further, the transmitting of the first control information format (e.g. DCI format 0) and the transmitting of the second control information (e.g. DCI format 0′) may be performed mutually exclusionary (i.e. in this case, it may not be possible to transmit DCI formats 0 and 0′ to a single UE 201 during the same sub-frame). In addition, e.g. the eNB 2021 may perform the equating only for the first control information format of a first type (e.g. DCI format 1A) transmitted on the second predetermined portion (e.g. DCI format 1A′), but not for the first control information format of the first type transmitted on the first predetermined portion, and may not perform the equating for the first control information of a second type (e.g. DCI format 0′) different from the first type.

Further, as shown in FIGS. 6A and 6D, the first and second portions may be non-overlapping with each other (as an example, the first portion may be constituted by the common search space, see FIG. 6A, and the second portion may be constituted by the UE-specific search space, see FIG. 6D).

Alternatively, as shown in FIGS. 6B and 6E, the first and second portions may partially overlap each other e.g. in a predetermined way (as an example, the first portion may be constituted by the entire common search space, and by the following portions of the UE-specific search space: channels 1 to 3 having 1 CCE, channels 1 to 3 having 2 CCEs, channel 1 having 4 CCEs and channel 1 having 8 CCEs (see FIG. 6B); and the second portion may be constituted by channels 1 and 2 having 4 CCEs and channel 1 having 8 CCEs of the common search space and the entire UE-specific search space).

Alternatively, as shown in FIGS. 6C and 6F, the first and second portions may fully overlap each other (as an example, the first portion may be constituted by the entire common and UE-specific search spaces, see FIG. 6C, and the second portion may be constituted by the entire common and UE-specific search spaces, see FIG. 6F).

As a further development pertaining to the eNB 2021 and the UE 201, the at least one transmission mode may involve a single-user multiple input multiple output, clustered resource block mapping and/or cross component carrier scheduling.

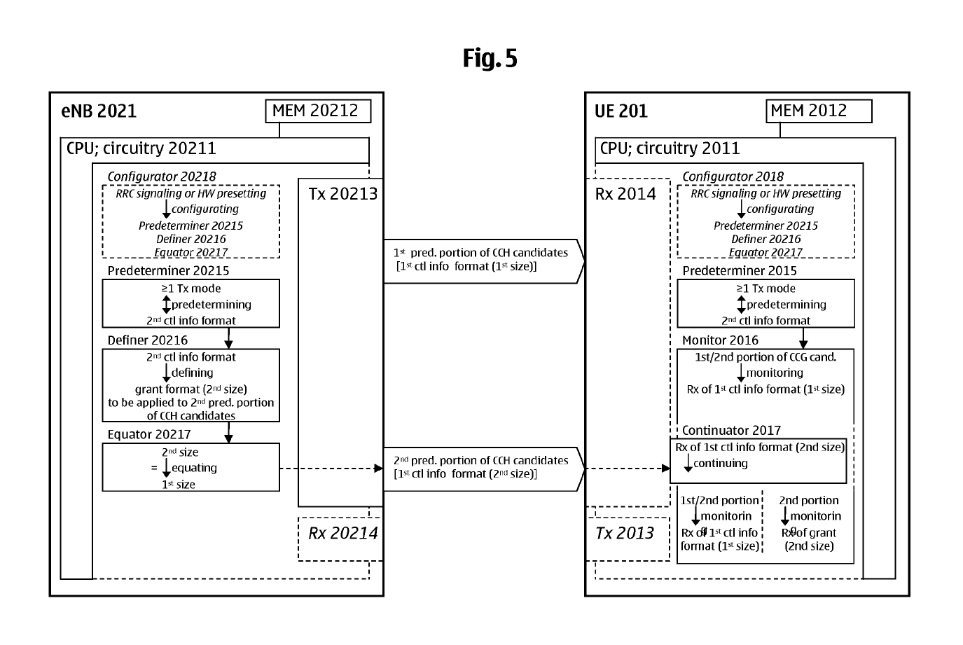

FIG. 5 shows apparatuses (e.g. the eNB 2021) for control information signaling according to the example of the present invention. Within FIG. 5, for ease of description, means or portions which may provide main functionalities are depicted with solid functional blocks or arrows and/or a normal font, while means or portions which may provide optional functions are depicted with dashed functional blocks or arrows and/or an italic font.

The UE 201 may comprise a CPU (or circuitry) 2011, a memory 2012, an optional transmitter (or means for transmitting) 2013, an optional receiver (or means for receiving) 2014, a predeterminer (or means for predetermining) 2015, a monitor (or means for monitoring) 2016, a continuator (or means for continuing) 2017 and an optional configurator (or means for configuring) 2018.

The eNB 2021 may comprise a CPU (or circuitry) 20221, a memory 20212, a transmitter (or means for transmitting) 20213, an optional receiver (or means for receiving) 20214, a predeterminer (or means for predetermining) 20215, a definer (or means for definer) 20216, an equator (or means for equating) 20217 and an optional configurator (or means for configuring) 20218.

As indicated by the dashed extensions of the functional blocks of the CPU 2011 or 20211, the means for predetermining 20215, the means for defining 20216, the means for equating 20217 and the means for configuring 20218 of the eNB 2021 and the means for predetermining 2015, the means for monitoring 2016, the means for continuing 2017 and the means for configuring 2018 (and the means for transmitting 2013 and means for receiving 2014 of the UE 201 as well as the means for transmitting 20213 and means for receiving 20214 of the eNB 2021) may be functionalities running on the CPU 2011 or 20211 of the UE 201 and the eNB 2021, or may alternatively be separate functional entities or means.

The CPUs 20x1 (wherein x=1 and/or 21) may respectively be configured, for example by software residing in the memory 20x2, to process various data inputs and to control the functions of the memories 20x2, the means for transmitting 202x3 and the means for receiving 20x4 (as well as the means for predetermining 20215, the means for defining 20216, the means for equating 20217 and the means for configuring 20218 of the eNB 2021 and the means for predetermining 2015, the means for monitoring 2016, the means for continuing 2017 and the means for configuring 2018). The memories 20x2 may serve e.g. for storing code means for carrying out e.g. the methods according to the example of the present invention, when run e.g. on the CPUs 20x1. It is to be noted that the means for transmitting 20x3 and the means for receiving 20x4 may alternatively be provided as respective integral transceivers. It is further to be noted that the transmitters/receivers may be implemented i) as physical transmitters/receivers for transceiving e.g. via the air interface (e.g. between the UE 201 and the eNB 2021), ii) as routing entities e.g. for transmitting/receiving data packets e.g. in a PS (packet switching) network (e.g. between the eNB 2021 and a further eNB (not shown) when disposed as separate network entities), iii) as functionalities for writing/reading information into/from a given memory area (e.g. in case of shared/common CPUs or memories e.g. of the eNB 2021 and a further eNB (not shown) when disposed as an integral network entity), or iv) as any suitable combination of i) to iii).

Optionally, e.g. the means for configuring 20218 of the eNB 2021 may perform configuring the means for predetermining, the means for defining and the means for equating based on higher layer signaling. Optionally, e.g. the means for configuring 2018 of the UE 201 may perform configuring the means for monitoring based on higher layer signaling. In these cases, the higher layer signaling may be constituted by dedicated radio resource control signaling. Alternatively, the higher layer signaling may be constituted by a preset hardware specification.

For example, the means for predetermining of the eNB 2021 and/or the means for predetermining of the UE 201 may perform predetermining, specifically for each of a plurality of terminals, at least one transmission mode (e.g. an UL transmission mode) in correspondence with a predetermined second control information format (e.g. DCI format 0′, 0″, 0′″ etc.).

Then, e.g. the means for transmitting 20213 of the eNB 2021 may perform transmitting, in a first predetermined portion of a set of control channel candidates (e.g. control channel elements (CCEs) for PDCCH), a first control information format (e.g. DCI format 0/1A) of a first size (e.g. size of DCI format 1A).

For example, the means for monitoring 2016 of the UE 201 may perform monitoring, in the first and second predetermined portions of the set of control channel candidates, reception of the first control information format of the first size.

For example, the means for defining 20216 of the eNB 2021 may perform defining, based on the second control information format, a scheduling grant format (e.g. UL grant format) of a second size different from the first size to be applied on a second predetermined portion of the set of control channel candidates.

Further, e.g. the means for equating 20217 of the eNB 2021 may perform equating the first size so as to match with the second size.

Finally, e.g. the means for transmitting 20213 of the eNB 2021 may perform transmitting, in the second predetermined portion, the equated first control information (e.g. DCI format 0′ or 1A′).

For example, the means for continuing 2017 of the UE 201 may perform continuing, upon reception of a configuration message relating to the at least one transmission mode, the monitoring.

For example, the means for monitoring 2016 of the UE 201 may perform monitoring, upon reception of the configuration message relating to the at least one transmission mode, reception of the scheduling grant format of the second size, the scheduling grant comprising the second control information format (e.g. DCI format 0′/1A′) in the second predetermined portion. In this case, the monitoring may comprise an operation in a single-antenna-port mode.

FIG. 6 shows a development of the example of the present invention as described hereinabove.

As shown in FIG. 6, as for those developments pertaining to the eNB 2021 and the UE 201, the first predetermined portion may be constituted by the common search space of the physical downlink control channel (see FIG. 6A). Further, the second predetermined portion may be constituted by the user equipment-specific search space of the physical downlink control channel (see FIG. 6D).

Further, as shown in FIGS. 6A and 6D, the first and second portions may be non-overlapping with each other (as an example, the first portion may be constituted by the common search space, see FIG. 6A, and the second portion may be constituted by the UE-specific search space, see FIG. 6D). Still further, the means for transmitting 20213 of the eNB 2021 may be configured to transmit the first control information format (e.g. DCI format 0) and the second control information (e.g. DCI format 0′) mutually exclusionary (i.e. in this case, it may not be possible to transmit DCI formats 0 and 0′ to a single UE 201 during the same sub-frame). In addition, e.g. the means for equating 20217 of the eNB 2021 may be configured to equate only for the first control information format of a first type (e.g. DCI format 1A) transmitted on the second predetermined portion (e.g. DCI format 1A′), but not for the first control information format of the first type transmitted on the first predetermined portion, and may not be configured to equate the first control information of a second type (e.g. DCI format 0′) different from the first type.

Alternatively, as shown in FIGS. 6B and 6E, the first and second portions may partially overlap each other e.g. in a predetermined way (as an example, the first portion may be constituted by the entire common search space, and by the following portions of the UE-specific search space: channels 1 to 3 having 1 CCE, channels 1 to 3 having 2 CCEs, channel 1 having 4 CCEs and channel 1 having 8 CCEs (see FIG. 6B); and the second portion may be constituted by channels 1 and 2 having 4 CCEs and channel 1 having 8 CCEs of the common search space and the entire UE-specific search space).

Alternatively, as shown in FIGS. 6C and 6F, the first and second portions may fully overlap each other (as an example, the first portion may be constituted by the entire common and UE-specific search spaces, see FIG. 6C, and the second portion may be constituted by the entire common and UE-specific search spaces, see FIG. 6F).

As a further development pertaining to the eNB 2021 and the UE 201, the at least one transmission mode may involve a single-user multiple input multiple output, clustered resource block mapping and/or cross component carrier scheduling.

Furthermore, at least one of, or more of the above-described means for predetermining 20215 or 2015, the means for transmitting 20213, the means for defining 20216, the means for equating 20217, the means for configuring 20218 or 2018, the means for monitoring 2016, the means for continuing 2017 as well as the eNB 2021 and the UE 201, or the respective functionalities carried out, may be implemented as a chipset, module or subassembly.

Finally, the example of present invention also relates to a system which may comprise the UE 201 and the eNB 2021 according to the above-described example of the present invention.

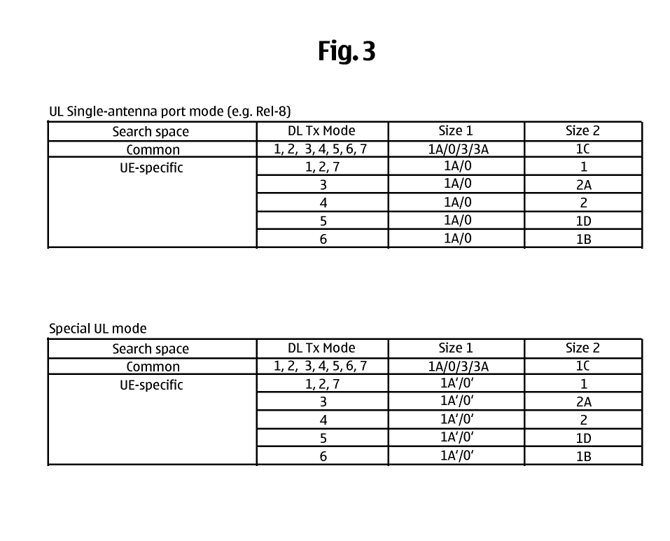

Without being restricted to the details following in this section, the examples of the present invention may be summarized as follows:
FIG. 3 shows a principle underlying the example of the present invention.
The blind decoding burden may be an issue for some UE vendors. For that reason, there is a need to consider resource allocation schemes maintaining the same blind decoding burden (per CC) at that e.g. in Rel-8. Also as mentioned, in addition to computational complexity issues, it is desirable to keep the number of blind decoding attempts low since increasing it also increases the probability of false grant detections that would cause false UL transmissions and hence add interference to the network.
CC aggregation may increase the blind decoding burden e.g. linearly a function with number of DL CCs allocated. However, in the case of cross-CC scheduling the blind decoding may be a problem due to the fact that CC bandwidth/Tx mode can vary from CC to CC (due to CC-dependent size for DCI). Hence in the worst case (i.e. cross-CC scheduling) maintaining the existing blind decoding burden per-CC would be highly desirable.
It is proposed (a) additional DCI format(s) and PDCCH blind decoding arrangement for UL grant while maintaining the fallback to legacy (this means that the eNB can dynamically schedule additional UL grants and Rel-8 grants) and keeping the PDCCH blind decoding at a pre-determined level (e.g., N x44, where N corresponds to number of DL and/or UL component carriers supported by the UE). It should be noted that UL is used only as an example. It is possible to apply similar structure also with DL RA signaling. This is achieved by configurable DCI and PDCCH search space arrangement according to the following steps:
1. At least one additional UL Tx mode is defined (on top of single antenna port mode using DCI Format 0 as in Rel-8) combined with a pre-defined DCI format (we call these additional DCI formats as 0′, 0″, 0′″, . . . ).
2. Regardless of the UL Tx mode, Rel-8-type of DCI format 0/1A is transmitted on the pre-defined (configured) portion of the PDCCH search space (=Portion 1). This arrangement provides fallback to Rel-8 DCI signaling (Size 1).
3. Higher-layer configured UL Tx mode defines the UL grant format (0/0′/0″) to be applied on another pre-defined (configured) portion of the PDCCH search space (=Portion 2).
4. Size of DCI format 1A transmitted via PDCCH Portion 2 is matched (→1A′) with that of UL grant (0/0′/0″).
The UE may perform according to the following:

UE is operating in single-antenna-port mode and monitors 0/1A from Portion 1 and Portion 2;

UE receives configuration message with respect to UL Tx Mode (e.g. SU-MIMO with 2-Tx antennas): continues monitoring of 0/1A from Portion 1 and starts monitoring 0′/1A′ (0′ corresponds to pre-defined UL Tx Mode) from Portion 2;

In case UE decodes PDCCH correctly (CRC check positive) it will act based on the received DCI (i.e., transmit PUSCH using single antenna-port-mode or special Tx mode according to 0/0′, or receive PDSCH according to 1A/1A′).
FIG. 3 shows the DL Tx mode-specific PDCCH blind decoding based on the proposed arrangement. In this example, PDCCH Portion 1 corresponds to a common PDCCH search space and Portion 2 a UE-specific search space, respectively.
It is noted that Portion 1 and Portion 2 are made fully non-overlapping in this example. This allows keep the PDCCH blind decoding at Rel-8 level (per CC). Generally speaking, Portion 1 and Portion 2 can be made also partially overlapping or fully overlapping, as shown in FIG. 6. These choices allow to trade off between the PDCCH blind decoding and overhead caused by matching the DCI Format 1A size with that of DCI Format 0′ as well as the PDCCH scheduling flexibility.
FIG. 6 shows three different exemplary arrangements for the PDCCH search space Portion 1 (search space for 1A/0) and Portion 2 (search space for 1A′/0′) according to the invention:

Non-overlapping search spaces→minimum PDCCH blind decoding (=Rel-8 level)

Partially overlapping search spaces→25% increase in PDCCH blind decoding (vs. Rel-8)

Fully overlapping search spaces→50% increase in PDCCH blind decoding (vs. Rel-8).
Configurability:
It is possible to configure the applied “PDCCH search space strategy” using higher layer signaling, e.g., dedicated RRC signaling. Alternatively, it is possible that the applied strategy is hard-wired in the specification.

### FURTHER EXAMPLES

For the purpose of the present invention as described herein above, it should be noted that

a circuitry may refer to at least one of, or hybrids of the following:

(a) to pure hardware circuit implementations (such as implementations purely in analog and/or digital circuitry), and

(b) to combinations of circuits and software (and/or firmware), such as (as applicable):
(i) a combination of processor(s), or
(ii) portions of processor(s)/software (including digital signal processor(s)), software and memory (or memories) that work together to cause an apparatus as defined hereinabove to perform various functions, and

(c) to circuits, such as (micro)processor(s) or a portion of (a) (micro)processor(s) that require software and/or firmware for operation even if the software or firmware is not physically present;

a processor may be any processing unit, such as CPU, arithmetic and logic unit (ALU), microprocessor unit (MPU), digital signal processor (DSP) etc., be it a single core processor, dual core processor or multi-core processor;

a program may be embodied by or on any computer program (product), computer readable medium, processor(s), memory (or memories), circuitry, circuits, random access memory (RAM), read-only memory (ROM) and/or data structure(s), be it e.g. as compiled/non-compiled program (source) code, executable object, (meta)file or the like;

an access technology may be any technology by means of which a user equipment can access an access network (or base station, respectively). Any present or future technology, such as WiMAX (Worldwide Interoperability for Microwave Access) or WLAN (Wireless Local area Network), BlueTooth, Infrared, and the like may be used; although the above technologies are mostly wireless access technologies, e.g. in different radio spectra, access technology in the sense of the present invention may also imply wirebound technologies, e.g. IP based access technologies like cable networks or fixed line.

a network may be any device, unit or means by which a station entity or other user equipment may connect to and/or utilize services offered by the access network; such services include, among others, data and/or (audio-) visual communication, data download etc.;

generally, the present invention may be applicable in those network/user equipment environments relying on a data packet based transmission scheme according to which data are transmitted in data packets and which are, for example, based on the internet protocol (IP). The present invention is, however, not limited thereto, and any other present or future IP or mobile IP (MIP) version, or, more generally, a protocol following similar principles as (M)IPv4/6, is also applicable;

a user equipment may be any device, unit or means by which a system user may experience services from an access network;

method steps likely to be implemented as software code portions and being run using a processor at a network element or terminal (as examples of devices, apparatuses and/or modules thereof, or as examples of entities including apparatuses, circuitries and/or modules therefore), are software code independent and can be specified using any known or future developed programming language as long as the functionality defined by the method steps is preserved;

generally, any method step is suitable to be implemented as software or by hardware without changing the idea of the invention in terms of the functionality implemented;

method steps and/or devices, units or means likely to be implemented as hardware components at the above-defined apparatuses, or any module(s)/circuitry(ies) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may alternatively be based on any security architecture capable e.g. of authentication, authorization, keying and/or traffic protection;

devices, units, circuitries or means (e.g. the above-defined apparatuses, or any one of their respective means) can be implemented as individual devices, units or means, but this does not exclude that they are implemented in a distributed fashion throughout the system, as long as the functionality of the device, unit circuitry or means is preserved;

an apparatus may be represented by a semiconductor chip, a chipset, a (hardware) module comprising such chip or chipset, or a circuitry; this, however, does not exclude the possibility that a functionality of an apparatus, module or circuitry, instead of being hardware implemented, be implemented as software in a (software) module such as a computer program or a computer program product comprising executable software code portions for execution/being run on a processor;

a device may be regarded as an apparatus or as an assembly of more than one apparatus, whether functionally in cooperation with each other or functionally independently of each other but in a same device housing, for example.

According to an example of the present invention, in a first aspect, this object is for example achieved by a method comprising:

predetermining, specifically for each of a plurality of terminals, at least one transmission mode in correspondence with a predetermined second control information format;

transmitting, in a first predetermined portion of a set of control channel candidates, a first control information format of a first size;

defining, based on the second control information format, a scheduling grant format of a second size different from the first size to be applied on a second predetermined portion of the set of control channel candidates;

equating the first size so as to match with the second size; and

transmitting, in the second predetermined portion, the equated first control information.

According to further refinements of the example of the present invention as defined under the above first aspect,

the transmitting of the first control information format and the transmitting of the second control information is performed mutually exclusionary;

the equating is performed only for the first control information format of a first type transmitted on the second predetermined portion, not for the first control information format of the first type transmitted on the first predetermined portion, and not for the first control information of a second type different from the first type;

the method further comprises configuring the predetermining, the defining and the equating based on higher layer signaling;

the higher layer signaling is constituted by dedicated radio resource control signaling;

the higher layer signaling is constituted by a preset hardware and/or software specification.

According to an example of the present invention, in a second aspect, this object is for example achieved by a method comprising:

predetermining, specifically for each of a plurality of terminals, at least one transmission mode in correspondence with a predetermined second control information format;

monitoring, in a first predetermined portion of a set of control channel candidates and a second predetermined portion of the set of control channel candidates, reception of a first control information format of a first size;

continuing, upon reception of a configuration message relating to the at least one transmission mode, the monitoring; and

monitoring, upon reception of a configuration message relating to the at least one transmission mode, reception of a scheduling grant format of a second size different from the first size, the scheduling grant comprising a second control information format in the second predetermined portion.

According to further refinements of the example of the present invention as defined under the above second aspect,

the monitoring comprises an operation in a single-antenna-port mode;

the method further comprises configuring the monitoring based on higher layer signaling.

According to further refinements of the example of the present invention as defined under the above first and second aspects,

the first predetermined portion is constituted by the common search space of the physical downlink control channel;

the second predetermined portion is constituted by the user equipment-specific search space of the physical downlink control channel;

the first and second portions are non-overlapping with each other;

the first and second portions are partially overlapping each other;

the first and second portions are fully overlapping each other;

the higher layer signaling is constituted by dedicated radio resource control signaling;

the higher layer signaling is constituted by a preset hardware and/or software specification;

the at least one transmission mode involves at least one of single-user multiple input multiple output, clustered resource block mapping and cross component carrier scheduling;

the at least one transmission mode is constituted by an uplink transmission mode;

the second control information format is constituted by a downlink control information format being related to at least one of single-user multiple input multiple output, clustered resource block mapping and cross component carrier scheduling;

the set of control channel candidates is constituted by a set of control channel elements for the physical downlink control channel;

the first control information format is constituted by a one of a downlink control information format 0 and a downlink control information format 1A.

According to an example of the present invention, in a third aspect, this object is for example achieved by an apparatus comprising:

means for predetermining, specifically for each of a plurality of terminals, at least one transmission mode in correspondence with a predetermined second control information format;

means for transmitting, in a first predetermined portion of a set of control channel candidates, a first control information format of a first size;

means for defining, based on the second control information format, a scheduling grant format of a second size different from the first size to be applied on a second pre-determined portion of the set of control channel candidates; and

means for equating the first size so as to match with the second size;

wherein the means for transmitting is configured to transmit, in the second predetermined portion, the equated first control information.

According to further refinements of the example of the present invention as defined under the above third aspect,

the means for transmitting is configured to transmit the first and second control information formats mutually exclusionary;

the means for equating is configured to equate only the first control information format of a first type transmitted on the second predetermined portion, not the first control information format of the first type transmitted on the first predetermined portion, and not the first control information of a second type different from the first type;

the apparatus further comprises means for configuring the means for predetermining, the means for defining and the means for equating based on higher layer signaling;

the apparatus is constituted by an evolved nodeB.

According to an example of the present invention, in a fourth aspect, this object is for example achieved by an apparatus comprising:

means for predetermining, specifically for each of a plurality of terminals, at least one transmission mode in correspondence with a predetermined second control information format;

means for monitoring, in a first predetermined portion of a set of control channel candidates and a second predetermined portion of the set of control channel candidates, reception of a first control information format of a first size; and

means for continuing, upon reception of a configuration message relating to the at least one transmission mode, the monitoring; wherein

the means for monitoring is configured to monitor, upon reception of a configuration message relating to the at least one transmission mode, reception of a scheduling grant format of a second size different from the first size, the scheduling grant comprising a second control information format in the second predetermined portion.

According to further refinements of the example of the present invention as defined under the above fourth aspect,

the means for monitoring is configured in a single-antenna-port mode;

the apparatus further comprises means for configuring the monitoring based on higher layer signaling;

the apparatus is constituted by a user equipment.

According to further refinements of the example of the present invention as defined under the above third and fourth aspects,

the first predetermined portion is constituted by the common search space of the physical downlink control channel;

the second predetermined portion is constituted by the user equipment-specific search space of the physical downlink control channel;

the first and second portions are non-overlapping with each other;

the first and second portions are partially overlapping each other;

the first and second portions are fully overlapping each other;

the higher layer signaling is constituted by dedicated radio resource control signaling;

the higher layer signaling is constituted by a preset hardware and/or software specification;

the at least one transmission mode involves at least one of single-user multiple input multiple output, clustered resource block mapping and cross component carrier scheduling;

the at least one transmission mode is constituted by an uplink transmission mode;

the second control information format is constituted by a downlink control information format being related to at least one of single-user multiple input multiple output, clustered resource block mapping and cross component carrier scheduling;

the set of control channel candidates is constituted by a set of control channel elements for the physical downlink control channel;

the first control information format is constituted by a one of a downlink control information format 0 and a downlink control information format 1A;

at least one, or more of means for predetermining, means for transmitting, means for defining, means for equating, means for configuring, means for monitoring, means for continuing and the apparatus is implemented as a chipset, module or subassembly.

According to an example of the present invention, in a fifth aspect, this object is for example achieved by an apparatus comprising:

a predeterminer configured to predetermine, specifically for each of a plurality of terminals, at least one transmission mode in correspondence with a predetermined second control information format;

a transmitter configured to transmit, in a first pre-determined portion of a set of control channel candidates, a first control information format of a first size;

a definer configured to define, based on the second control information format, a scheduling grant format of a second size different from the first size to be applied on a second predetermined portion of the set of control channel candidates; and

an equator configured to equate the first size so as to match with the second size;

wherein the transmitter is configured to transmit, in the second predetermined portion, the equated first control information.

According to further refinements of the example of the present invention as defined under the above fifth aspect,

the transmitter is configured to transmit the first and second control information formats mutually exclusionary;

the equator is configured to equate only the first control information format of a first type transmitted on the second predetermined portion, not the first control information format of the first type transmitted on the first predetermined portion, and not the first control information of a second type different from the first type;

the apparatus further comprises a configurator configured to configure the predeterminer, the definer and the equator based on higher layer signaling;

the apparatus is constituted by an evolved nodeB.

According to an example of the present invention, in a sixth aspect, this object is for example achieved by an apparatus comprising:

a predeterminer configured to predetermine, specifically for each of a plurality of terminals, at least one transmission mode in correspondence with a predetermined second control information format;

a monitor configured to monitor, in a first predetermined portion of a set of control channel candidates and a second predetermined portion of the set of control channel candidates, reception of a first control information format of a first size; and

a continuer configured to continue, upon reception of a configuration message relating to the at least one transmission mode, the monitoring; wherein

the monitor is configured to monitor, upon reception of a configuration message relating to the at least one transmission mode, reception of a scheduling grant format of a second size different from the first size, the scheduling grant comprising a second control information format in the second predetermined portion.

According to further refinements of the example of the present invention as defined under the above sixth aspect,

the monitor is configured in a single-antenna-port mode;

the apparatus further comprises a configurator configured to configure the monitoring based on higher layer signaling;

the apparatus is constituted by a user equipment.

According to further refinements of the example of the present invention as defined under the above fifth and sixth aspects,

the first predetermined portion is constituted by the common search space of the physical downlink control channel;

the second predetermined portion is constituted by the user equipment-specific search space of the physical downlink control channel;

the first and second portions are non-overlapping with each other;

the first and second portions are partially overlapping each other;

the first and second portions are fully overlapping each other;

the higher layer signaling is constituted by dedicated radio resource control signaling;

the higher layer signaling is constituted by a preset hardware and/or software specification;

the at least one transmission mode involves at least one of single-user multiple input multiple output, clustered resource block mapping and cross component carrier scheduling;

the at least one transmission mode is constituted by an uplink transmission mode;

the second control information format is constituted by a downlink control information format being related to at least one of single-user multiple input multiple output, clustered resource block mapping and cross component carrier scheduling;

the set of control channel candidates is constituted by a set of control channel elements for the physical downlink control channel;

the first control information format is constituted by a one of a downlink control information format 0 and a downlink control information format 1A;

at least one, or more of the predeterminer, the transmitter, the definer, the equator, the configurator, the monitor, the continuer and the apparatus is implemented as a chipset, module or subassembly.

According to an example of the present invention, in a seventh aspect, this object is for example achieved by a system comprising:

an apparatus according to the above third or fifth aspect; and

an apparatus according to the above fourth or fifth aspect.

According to an example of the present invention, in an eighth aspect, this object is for example achieved by a computer program product comprising code means for performing a method according to the above first or second aspects when run on a processing means or module.

According to an example of the present invention, in a ninth aspect, this object is for example achieved by a computer program comprising code means for performing, when run on a processing means or module, a method comprising:

predetermining, specifically for each of a plurality of terminals, at least one transmission mode in correspondence with a predetermined second control information format;

transmitting, in a first predetermined portion of a set of control channel candidates, a first control information format of a first size;

defining, based on the second control information format, a scheduling grant format of a second size different from the first size to be applied on a second predetermined portion of the set of control channel candidates;

equating the first size so as to match with the second size; and

transmitting, in the second predetermined portion, the equated first control information.

According to an example of the present invention, in a tenth aspect, this object is for example achieved by a computer program comprising code means for performing, when run on a processing means or module, a method comprising:

predetermining, specifically for each of a plurality of terminals, at least one transmission mode in correspondence with a predetermined second control information format;

monitoring, in a first predetermined portion of a set of control channel candidates and a second predetermined portion of the set of control channel candidates, reception of a first control information format of a first size;

continuing, upon reception of a configuration message relating to the at least one transmission mode, the monitoring; and

monitoring, upon reception of a configuration message relating to the at least one transmission mode, reception of a scheduling grant format of a second size different from the first size, the scheduling grant comprising a second control information format in the second predetermined portion.

Although the present invention has been described herein before with reference to particular embodiments thereof, the present invention is not limited thereto and various modification can be made thereto.

1-36. (canceled)

37. A method for controlling a blind decoding burden, comprising:
determining an transmission mode in correspondence with a predetermined second control information format;
transmitting in a first predetermined portion of a set of control channel candidates a first control information format of a first size, said first control information format and first size independent of said at least one transmission mode; and
dependent on said at least one transmission mode, transmitting in a second predetermined portion of the set of control channel candidates a scheduling grant format of a second size different from the first size based on the second control information format or transmitting in the second predetermined portion of the set of control channel candidates the first control information format of the first size.

38. A method for controlling a blind decoding burden, comprising:
determining at least one transmission mode in correspondence with a predetermined second control information format;
monitoring a first predetermined portion of a set of control channel candidates for a first control information format of a first size, said first control information format and first size independent of said at least one transmission mode; and
dependent on said at least one transmission mode, monitoring a second predetermined portion of the set of control channel candidates for a scheduling grant format of a second size different from the first size based on the second control information format or monitoring the second predetermined portion of the set of control channel candidates for the first control information format of the first size.

39. The method according to claim 38, wherein the monitoring the first and second predetermined portion of a set of control channel candidates occurs at least in part simultaneously.

40. The method according to claim 38, wherein the first and second predetermined portions of the set of control channel candidates are non-overlapping.

41. The method according to claim 38, wherein the at least one transmission mode is an uplink transmission mode.

42. The method according to claim 38, wherein the at least one transmission mode is conveyed through a configuration message.

43. The method according to claim 38, wherein the blind decoding burden is independent of the at least one transmission mode.

44. The method according to claim 38, wherein the first predetermined portion comprises a common search space and the second predetermined portion comprises a user equipment specific search space.

45. The method according to claim 44,
wherein the first control information format comprises a Long Term Evolution Downlink Control Information format 0 and the second control information format comprises a Long Term Evolution Downlink Control Information format 0 modified according to said transmission mode with additional bits; or
wherein the first control information format comprises a Long Term Evolution Downlink Control Information format 1A and the second control information format comprises a Long Term Evolution Downlink Control Information format 1A modified according to said transmission mode with additional bits.

46. The method according to claim 38,
wherein the at least one transmission mode involves at least one of single-user multiple input multiple output, clustered resource block mapping and cross component carrier scheduling.

47. The method according to claim 38,
wherein the second control information format comprises a Long Term Evolution Downlink Control Information format 1A modified with additional bits such that its size is matched to Long Term Evolution Downlink Control Information format 0 modified according to said transmission mode.

48. An apparatus for controlling a blind decoding burden, comprising at least one processor; and at least one memory including computer program code; the at least one memory and the computer program code configured to, with the at least one processor, cause the apparatus at least to:
determine at least one transmission mode in correspondence with a predetermined second control information format;
monitor a first predetermined portion of a set of control channel candidates for a first control information format of a first size, said first control information format and first size independent of said at least one transmission mode; and
dependent on said at least one transmission mode, monitor a second predetermined portion of the set of control channel candidates for a scheduling grant format of a second size different from the first size based on the second control information format or monitor the second predetermined portion of the set of control channel candidates for the first control information format of the first size.

49. The apparatus according to claim 48, wherein the apparatus monitors the first and second predetermined portion of a set of control channel candidates at least in part simultaneously.

50. The method according to claim 48, wherein the first and second predetermined portions of the set of control channel candidates are non-overlapping.

51. The apparatus according to claim 48, wherein the at least one transmission mode is an uplink transmission mode.

52. The apparatus according to claim 48, wherein the blind decoding burden is independent of the at least one transmission mode.

53. The apparatus according to claim 48, wherein the first predetermined portion comprises a common search space and the second predetermined portion comprises a user equipment specific search space.

54. The apparatus according to claim 48,
wherein the first control information format comprises a Long Term Evolution Downlink Control Information format 0 and the second control information format comprises a Long Term Evolution Downlink Control Information format 0 modified according to said transmission mode with additional bits; or
wherein the first control information format comprises a Long Term Evolution Downlink Control Information format 1A and the second control information format comprises a Long Term Evolution Downlink Control Information format 1A modified according to said transmission mode with additional bits.

55. The apparatus according to claim 48,
wherein the second control information format comprises a Long Term Evolution Downlink Control Information format 1A modified with additional bits such that its size is matched to Long Term Evolution Downlink Control Information format 0 modified according to said transmission mode.

56. The apparatus according to claim 48,
wherein the at least one transmission mode involves at least one of single-user multiple input multiple output, clustered resource block mapping and cross component carrier scheduling.
